(19) United States
(12) Patent Application Publication
(10) Pub. No.: US 2022/0201276 A1
(43) Pub. Date: Jun. 23, 2022

(54) NAKED EYE STEREOSCOPIC DISPLAY AND CONTROL METHOD THEREOF

(71) Applicant: Acer Incorporated, New Taipei City (TW)

(72) Inventors: Yen-Hsien LI, New Taipei City (TW); Shih-Ting HUANG, New Taipei City (TW); Chao-Shih HUANG, New Taipei City (TW)

(73) Assignee: Acer Incorporated, New Taipei City (TW)

(21) Appl. No.: 17/535,233

(22) Filed: Nov. 24, 2021

(30) Foreign Application Priority Data
Dec. 18, 2020 (TW) 109144998

(51) Int. Cl. H04N 13/366; H04N 13/305

(52) U.S. Cl. CPC H04N 13/366; H04N 13/305

(57) ABSTRACT

A naked eye stereoscopic display and a control method thereof are provided. The control method of a naked eye stereoscopic display includes the following steps. An effective image width of one eye is obtained. The eye is tracked to obtain an eye movement vector, a movement speed vector and a moving acceleration vector. A correction vector is obtained according to the effective image width, the movement speed vector and the moving acceleration vector. The eye movement vector is corrected according to the correction vector. An image position of a monocular image at several pixels is corrected according to the eye movement vector, which is corrected.

This application claims the benefit of Taiwan application Serial No. 109144998, filed Dec. 18, 2020, the disclosure of which is incorporated by reference herein in its entirety.

### TECHNICAL FIELD

The disclosure relates in general to a display and a control method thereof, and more particularly to a naked eye stereoscopic display and a control method thereof.

### BACKGROUND

Along with the rapid advance in the display technology, various stereoscopic display techniques are provided. The naked eye stereoscopic display allows the user to view stereoscopic images without having to wear 3D glasses. Driven by the convenience of use, the naked eye stereoscopic display has gradually become an important item in the stereoscopic display technology.

Through the use of lenticular lens array, the naked eye stereoscopic display allows the left eye and the right eye to receive different images, which provide a stereoscopic vision to the user. However, once the user moves, the left eye and the right eye will not be able to correctly receive the predetermined images, and the user's stereoscopic vision will be blurred.

### SUMMARY

The present disclosure relates to a naked eye stereoscopic display and a control method thereof which consider the user's speed and acceleration, such that image position can be further corrected and the delay and discrepancy between the imaging and user's movement can be reduced.

According to one embodiment, a control method of a naked eye stereoscopic display is provided. The control method of a naked eye stereoscopic display includes the following steps. An effective image width of one eye is obtained. The eye is tracked to obtain an eye movement vector, a movement speed vector and a moving acceleration vector. A correction vector is obtained according to the effective image width, the movement speed vector and the moving acceleration vector. The eye movement vector is corrected according to the correction vector. An image position of a monocular image at several pixels is corrected according to the eye movement vector which is corrected.

According to another embodiment, a naked eye stereoscopic display is provided. The naked eye stereoscopic display includes an eye tracking unit, a vector calculation unit, a space correction unit and an image processing unit. The eye tracking unit is configured to track an eye to obtain an eye movement vector, a movement speed vector and a moving acceleration vector of the eye. The vector calculation unit is configured to obtain a correction vector according to the effective image width, the movement speed vector and the moving acceleration vector. The space correction unit is configured to correct the eye movement vector according to the correction vector. The image processing unit is configured to correct an image position of a monocular image at several pixels according to the eye movement vector, which is corrected.

The above and other aspects of the present disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a naked eye stereoscopic display according to an embodiment.

FIG. 2 is a diagram illustrating the brightness change in the left eye image viewed by the left eye when the user is moving.

FIG. 3 is a block diagram of a naked eye stereoscopic display according to an embodiment.

FIG. 4 is a flowchart of a control method of a naked eye stereoscopic display according to an embodiment.

FIG. 5 is a bionic crosstalk curve according to an embodiment.

FIG. 6 is a relationship diagram of distance between effective image width, left eye and naked eye stereoscopic display according to an embodiment.

FIG. 7 is a correction diagram of a left eye image viewed by the left eye according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

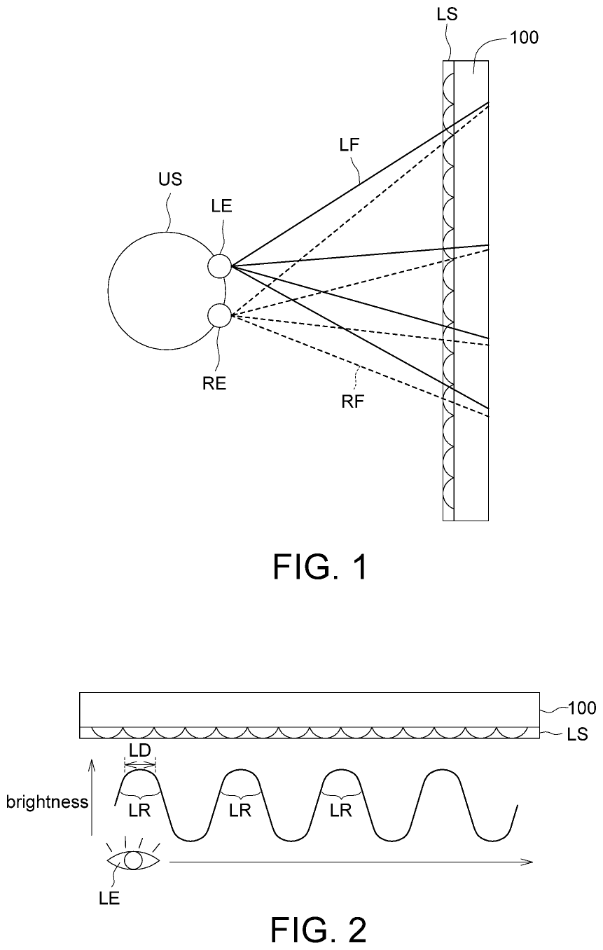

Referring to FIG. 1, a schematic diagram of a naked eye stereoscopic display 100 according to an embodiment is shown. The naked eye stereoscopic display 100 mainly allows a part of pixels to display a left eye image LF, allows a left eye image LF to be successfully imaged at the left eye LE through a lenticular lens array LS, allows the remaining pixels to display a right eye image RF, and allows a right eye image RF to be successfully imaged at the right eye RE through the lenticular lens array LS.

Referring to FIG. 2, a diagram illustrating the brightness change in the left eye image LF viewed by the left eye LE when the user is moving is shown. When the naked eye stereoscopic display 100 displays the left eye image LF on a part of pixels, a regional focus will be formed at the front of the lenticular lens array LS. Therefore, when the user US moves to the right, the brightness received by the left eye LE will increase or decrease along with the movement. As indicated in FIG. 2, several maximum brightness ranges LR are formed at the front of the lenticular lens array LS. The width of each maximum brightness range LR is the effective image width LD. Only when the left eye LE falls within the maximum brightness range LR will the left eye image LF be successfully imaged at the left eye LE. When the left eye LE falls outside the maximum brightness range LR, the left eye image LF cannot be correctly imaged at the left eye LE.

Therefore, when the user US moves, the left eye image LF may not be correctly imaged at the left eye LE, and the right eye image RF may not be correctly imaged at the right eye RE either. The research personnel find that when the user US moves, for the left eye image LF to be correctly imaged at the left eye LE, the image position of the left eye image LF at these pixels must be corrected according to the movement of the left eye LE. Similarly, for the right eye image RF to be correctly imaged at the right eye RE, the image position of the right eye image RF at these pixels must be corrected according to the movement of the right eye RE.

To achieve the above correction, an eye position tracking procedure and an image position correcting procedure must be performed. However, since the eye position tracking procedure and the image position correcting procedure both require a certain amount of time for processing and calculation and cannot catch up with the movement of the user US, the left eye image LF cannot be correctly imaged at the left eye LE and the right eye image RF cannot be correctly imaged at the right eye RE either.

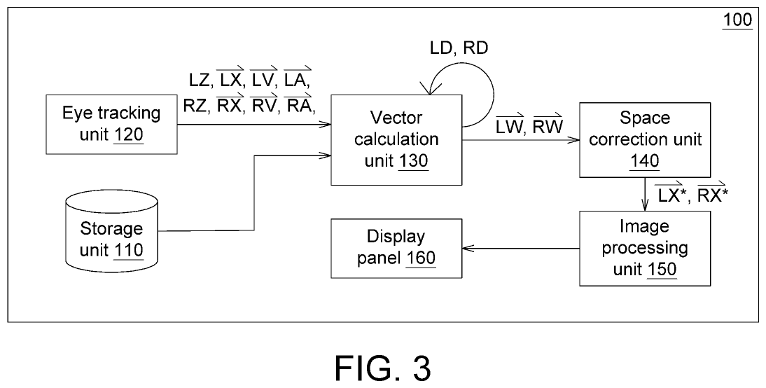

For the left eye image LF and the right eye image RF to be correctly imaged at the left eye LE and the right eye RE respectively, the research personnel further consider the speed and acceleration of the user US, such that the image position can be further corrected. Referring to FIG. 3, a block diagram of a naked eye stereoscopic display 100 according to an embodiment is shown. The naked eye stereoscopic display 100 includes a storage unit 110, an eye tracking unit 120, a vector calculation unit 130, a space correction unit 140, an image processing unit 150 and a display panel 160. Functions of each element are briefed as follows. The storage unit 110 is configured to store data. The eye tracking unit 120 is configured to perform the eye tracking procedure. The vector calculation unit 130 is configured to perform vector calculation. The space correction unit 140 is configured to correct the three-dimensional spatial position. The image processing unit 150 is configured to perform an imaging procedure. The display panel 160 is configured to display images. The storage unit 110 can be realized by such as a memory, a hard disc or a cloud data center. The eye tracking unit 120 can be realized by such as a depth camera or a point cloud camera. The vector calculation unit 130, the space correction unit 140 and the image processing unit 150 can be realized by such as a programming code, a circuit, a chip, a circuit board or a storage device storing programming codes. In the present embodiment, the vector calculation unit 130 and the space correction unit 140 consider the speed and acceleration of the user US, such that the image position can be further corrected and the delay and discrepancy between the imaging and the movement of the user US can be reduced. Detailed descriptions of the operations of each element disclosed above are disclosed below with an accompanying flowchart.

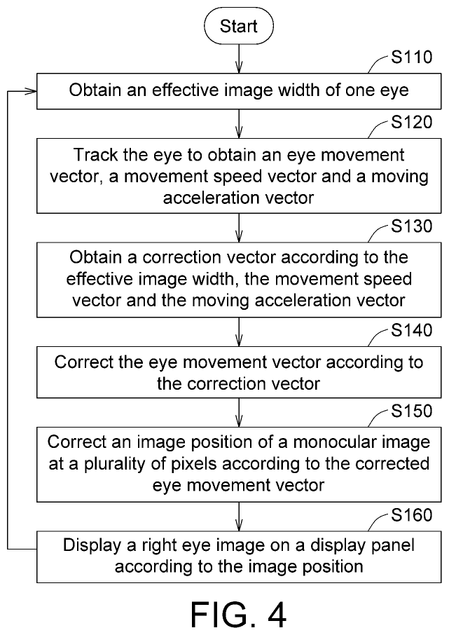

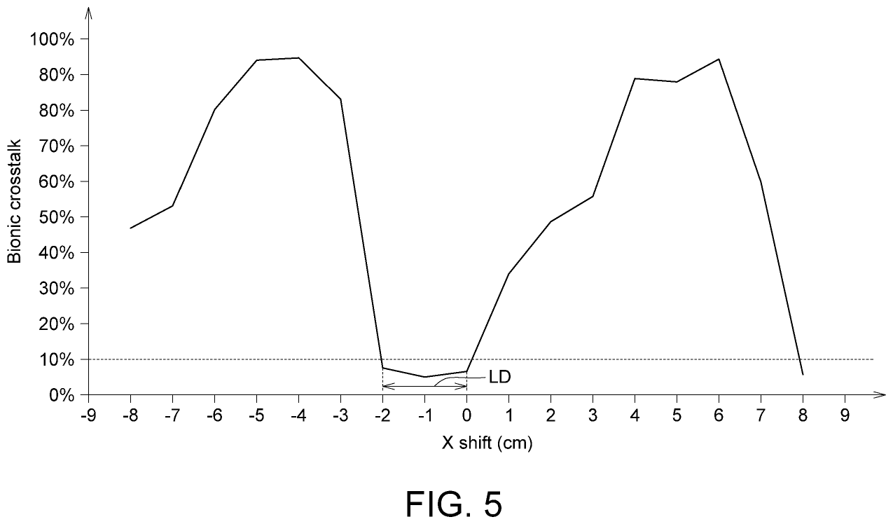

Referring to FIG. 4, a flowchart of a control method of a naked eye stereoscopic display 100 according to an embodiment is shown. In step S110, an effective image width of one eye is obtained. The method is exemplified by the effective image width LD of the left eye LE. Referring to FIG. 5, a bionic crosstalk curve according to an embodiment is shown. The bionic crosstalk curve of FIG. 5 describes the measurement result of the left eye LE and is obtained according to formula (1).

LBC=(RWB−RBB)/(LWB−LBB+RWB−RBB) (1)

Wherein, LBC represents a bionic crosstalk percentage of the left eye LE; RWB represent a brightness value of a left eye image LF being all white and a right eye image being all black received by the right eye RE; RBB represents a brightness value of a left eye image LF being all black and a right eye image being all black received by the right eye RE; LWB represents a brightness value of a left eye image LF being all white and a right eye image being all black received by the left eye LE; and LBB represents a brightness value of a left eye image LF being all black and a right eye image being all black received by the left eye LE. As indicated in FIG. 5, the range of the bionic crosstalk percentage below a predetermined percentage can be defined as the effective image width LD of the left eye LE. The predetermined percentage is such as 10%.

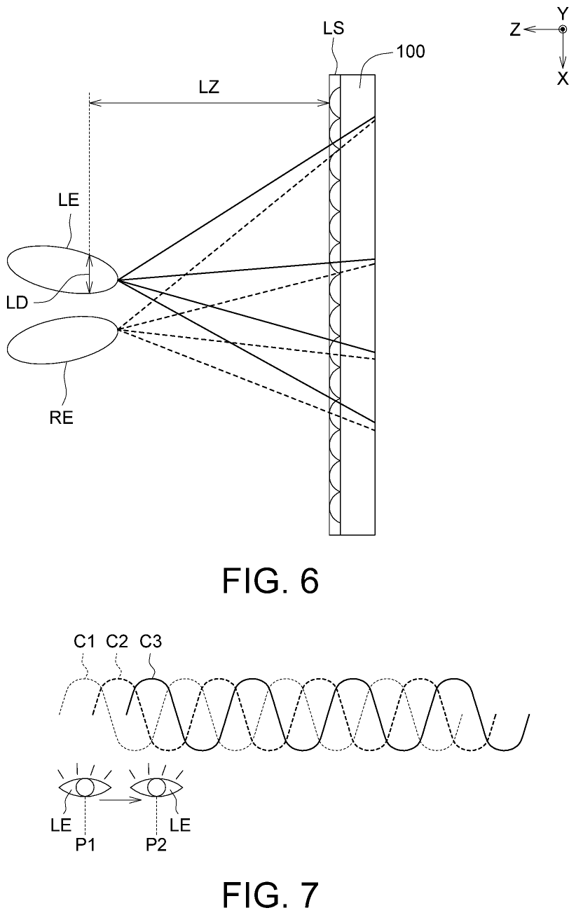

Referring to FIG. 6, a relationship diagram of a distance LZ between effective image width LD, left eye LE and naked eye stereoscopic display 100 according to an embodiment is shown. The bionic crosstalk curve of the left eye LE varies with the distance LZ, therefore the effective image width LD relates to the distance LZ. In an embodiment, the storage unit 110 (illustrated in FIG. 3) can store a cross-reference table TB of the effective image width LD and the distance LZ. After the vector calculation unit 130 obtains the distance LZ and the cross-reference table TB from the eye tracking unit 120 and the storage unit 110 respectively, the effective image width LD can then be obtained.

Then, the method proceeds to step S120, the left eye LE is tracked by the eye tracking unit 120 to obtain an eye movement vector [symbol] , a movement speed vector [symbol] and a moving acceleration vector [symbol] . The eye movement vector [symbol] can be three-dimensional vector. The movement speed vector [symbol] and the moving acceleration vector [symbol] can be three-dimensional vectors.

Then, the method proceeds to step S130, a correction vector [symbol] is obtained by the vector calculation unit 130 according to the effective image width LD, the movement speed vector [symbol] and the moving acceleration vector [symbol] . The correction vector [symbol] can be obtained according to formula (2).

$$\vec{LW} ( \vec{LV} , \vec{LA} ) = \vec{i} \frac{LD}{4} ( \frac{\vec{LV} \cdot \vec{i}}{\vert \vec{LV} \cdot \vec{i} \vert} ) ( 1 + \frac{\vec{LV} \cdot \vec{i}}{\vert \vec{LV} \cdot \vec{i} \vert} \frac{\vec{LA} \cdot \vec{i}}{\vert \vec{LA} \cdot \vec{i} \vert} \frac{\vert \vec{LA} \vert}{\vert {\vec{LA}}_{max} \vert} ) k \qquad ( 2 )$$

Wherein, [symbol] represents a unit vector in the X-axis direction (illustrated in FIG. 6); [symbol] ₘₐₓ represents a maximum of the moving acceleration vector [symbol] ; and k represents a weighted correction coefficient.

$$\frac{\vec{LV} \cdot \vec{i}}{\vert \vec{LV} \cdot \vec{i} \vert}$$

calculated to determine whether the movement speed vector [symbol] is a positive direction in the X-axis direction: if the movement speed vector [symbol] is a positive direction in the X-axis direction, then a positive value is obtained; if the movement speed vector [symbol] is a negative direction in the X-axis direction, then a negative value is obtained.

$$\frac{\vec{LA} \cdot \vec{i}}{\vert \vec{LA} \cdot \vec{i} \vert}$$

calculated to determine whether the moving acceleration vector [symbol] is a positive direction in the X-axis direction: if the moving acceleration vector [symbol] is a positive direction in the X-axis direction, then a positive value is obtained; if the moving acceleration vector [symbol] is a negative direction in the X-axis direction, then a negative value is obtained.

$$\frac{\vec{LV} \cdot \vec{i}}{\vert \vec{LV} \cdot \vec{i} \vert} \frac{\vec{LA} \cdot \vec{i}}{\vert \vec{LA} \cdot \vec{i} \vert}$$

calculated to determine whether the movement speed vector [symbol] and the moving acceleration vector [symbol] have the same direction: if the movement speed vector [symbol] and the moving acceleration vector [symbol] have the same direction, then a positive value is obtained; if the movement speed vector [symbol] and the moving acceleration vector [symbol] have opposite directions, then a negative value is obtained.

$$\frac{\vert \vec{LA} \vert}{\vert {\vec{LA}}_{max} \vert}$$

calculates a ratio of the moving acceleration vector [symbol] relative to the maximum, and a ratio between 0 and 1 is obtained.

The value of k is such as between 0.5 and 1.2.

According to formula (2), when the movement speed vector [symbol] is a positive direction in the X-axis direction, the correction vector [symbol] is the positive direction.

When the movement speed vector [symbol] is a positive direction in the X-axis direction and the movement speed vector [symbol] and the moving acceleration vector [symbol] have the same direction, the correction vector [symbol] is a positive direction and will be increased to a larger value.

When the movement speed vector [symbol] is a positive direction in the X-axis direction and the movement speed vector [symbol] and the moving acceleration vector [symbol] have opposite directions, the correction vector [symbol] is a positive direction but will be decreased to a smaller value.

When the movement speed vector [symbol] is a negative direction in the X-axis direction, the correction vector [symbol] is a negative direction.

When the movement speed vector [symbol] is a negative direction in the X-axis direction and the movement speed vector [symbol] and the moving acceleration vector [symbol] have the same direction, the correction vector [symbol] is a negative direction and will be increased to a larger value.

When the movement speed vector [symbol] is a negative direction in the X-axis direction and the movement speed vector [symbol] and the moving acceleration vector [symbol] have opposite directions, the correction vector [symbol] is a negative direction but will be decreased to a smaller value.

Then, the method proceeds to step S140, the eye movement vector [symbol] is corrected by the space correction unit 140 according to the correction vector [symbol] . The eye movement vector [symbol] can be corrected according to formula (3).

[symbol]

*= [symbol] + [symbol] (3)

Then, the method proceeds to step S150, an image position of a monocular image (such as the left eye image LF) at several pixels is corrected by the image processing unit 150 according to the eye movement vector [symbol] *, which is corrected. The estimated eye coordinates can be calculated according to the eye movement vector [symbol] *, then the image position of the corresponding pixels can be obtained according to the Snell's Law through reverse calculation of the lens geometric relationship.

Then, the method proceeds to step S160, the monocular image (such as the left eye image LF) is displayed by the display panel 160 according to the image position.

Similarly, the right eye image RF of the right eye RE can also be displayed according to the above process. In step S110, an effective image width RD of the right eye RE is obtained. A bionic crosstalk curve (not illustrated) can be plotted with respect to the effective image width RD of the right eye RE according to formula (4).

RBC=(LWB−LBB)/(LWB−LBB+RWB−RBB) (4)

Wherein, RBC represents a bionic crosstalk percentage of the right eye RE.

Then, the method proceeds to step S120, the right eye RE is tracked by the eye tracking unit 120 to obtain an eye movement vector [symbol] , a movement speed vector [symbol] and a moving acceleration vector [symbol] . The eye movement vector [symbol] can be three-dimensional coordinates. The movement speed vector [symbol] and the moving acceleration vector [symbol] can be three-dimensional vectors.

Then, the method proceeds to step S130, a correction vector [symbol] is obtained by the vector calculation unit 130 according to the effective image width RD, the movement speed vector [symbol] and the moving acceleration vector [symbol] . The correction vector [symbol] can be obtained according to formula (5).

$$\vec{RW} ( \vec{RV} , \vec{RA} ) = \vec{i} \frac{RD}{4} ( \frac{\vec{RV} \cdot \vec{i}}{\vert \vec{RV} \cdot \vec{i} \vert} ) ( 1 + \frac{\vec{RV} \cdot \vec{i}}{\vert \vec{RV} \cdot \vec{i} \vert} \frac{\vec{RA} \cdot \vec{i}}{\vert \vec{RA} \cdot \vec{i} \vert} \frac{\vert \vec{RA} \vert}{\vert {\vec{RA}}_{max} \vert} ) k \qquad ( 5 )$$

Wherein, [symbol] _{Amax} represents a maximum of the moving acceleration vector [symbol] .

$$\frac{\vec{RV} \cdot \vec{i}}{\vert \vec{RV} \cdot \vec{i} \vert}$$

calculated to determine whether the movement speed vector [symbol] is a positive direction in the X-axis direction: if the movement speed vector [symbol] is a positive direction in the X-axis direction, then a positive value is obtained; if the movement speed vector [symbol] is a negative direction in the X-axis direction, then a negative value is obtained.

$$\frac{\vec{RA} \cdot \vec{i}}{\vert \vec{RA} \cdot \vec{i} \vert}$$

is calculated to determine whether the moving acceleration vector [symbol] is a positive direction in the X-axis direction: if the moving acceleration vector [symbol] is a positive direction in the X-axis direction, then a positive value is obtained; if the moving acceleration vector [symbol] is a negative direction in the X-axis direction, then a negative value is obtained.

$$\frac{\vec{RV} \cdot \vec{i}}{\vert \vec{RV} \cdot \vec{i} \vert} \frac{\vec{RA} \cdot \vec{i}}{\vert \vec{RA} \cdot \vec{i} \vert}$$

is calculated to determine whether the movement speed vector [symbol] and the moving acceleration vector [symbol] have the same direction: if the movement speed vector [symbol] and the moving acceleration vector [symbol] have the same direction, then a positive value is obtained; if the movement speed vector [symbol] and the moving acceleration vector [symbol] have opposite directions, then a negative value is obtained.

$$\frac{\vert \vec{RA} \vert}{\vert {\vec{RA}}_{max} \vert}$$

calculates a ratio of the moving acceleration vector [symbol] relative to the maximum, and a ratio between 0 and 1 is obtained.

According to formula (5), when the movement speed vector [symbol] is a positive direction in the X-axis direction, the correction vector [symbol] is a positive direction.

When the movement speed vector [symbol] is a positive direction in the X-axis direction and the movement speed vector [symbol] and the moving acceleration vector [symbol] have the same direction, the correction vector [symbol] is the positive direction and will be increased to a larger value.

When the movement speed vector [symbol] is a positive direction in the X-axis direction and the movement speed vector [symbol] and the moving acceleration vector [symbol] have opposite directions, the correction vector [symbol] is a positive direction but will be decreased to a smaller value.

When the movement speed vector [symbol] is a negative direction in the X-axis direction, the correction vector [symbol] is a negative direction.

When the movement speed vector [symbol] is a negative direction in the X-axis direction, and the movement speed vector [symbol] and the moving acceleration vector [symbol] have the same direction, the correction vector [symbol] is a negative direction and will be increased to a larger value.

When the movement speed vector [symbol] is a negative direction in the X-axis direction, and the movement speed vector [symbol] and the moving acceleration vector [symbol] have opposite directions, the correction vector [symbol] is a negative direction but will be decreased to a smaller value.

Then, the method proceeds to step S140, the eye movement vector [symbol] is corrected by the space correction unit 140 according to the correction vector [symbol] . The eye movement vector [symbol] is corrected according to formula (6).

[symbol]

*= [symbol] + [symbol] (6)

Then, the method proceeds to step S150, an image position of the right eye image RF at several pixels is corrected by the image processing unit 150 according to the eye movement vector [symbol] *, which is corrected.

Then, the method proceeds to step S160, the right eye image RF is displayed on the display panel 160 according to the image position.

Referring to FIG. 7, a correction diagram of a left eye image LF viewed by the left eye LE according to an embodiment is shown. When the left eye LE is moved to position P2 from position P1 and the image is not corrected, the maximum value of the brightness curve C1 of the left eye image LF will not be aligned with the left eye LE.

When the left eye image LF is corrected according to the eye movement vector [symbol] , the maximum value of the brightness curve C2, which is corrected, of the left eye image LF still cannot catch up with the movement of the left eye LE due to the computing delay.

When the left eye image LF is corrected according to the eye movement vector [symbol] , the movement speed vector [symbol] and the moving acceleration vector [symbol] , the maximum of the brightness curve C3, which is corrected, of the left eye image LF can catch up with the movement of the left eye LE.

As disclosed in the above embodiments, the naked eye stereoscopic display 100 and the control method thereof consider user's speed and acceleration, such that the image position can be further corrected and the delay and discrepancy between the imaging and the user's movement can be reduced.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A control method of a naked eye stereoscopic display, comprising:
obtaining an effective image width of one eye;
tracking the eye to obtain an eye movement vector, a movement speed vector and a moving acceleration vector;
obtaining a correction vector according to the effective image width, the movement speed vector and the moving acceleration vector;
correcting the eye movement vector according to the correction vector; and
correcting an image position of a monocular image at a plurality of pixels according to the eye movement vector which is corrected.

2. The control method of the naked eye stereoscopic display according to claim 1, wherein a direction of the correction vector relates to a direction of the movement speed vector.

3. The control method of the naked eye stereoscopic display according to claim 1, wherein value of the correction vector relates to directional consistency between the movement speed vector and the moving acceleration vector.

4. The control method of the naked eye stereoscopic display according to claim 1, wherein value of the correction vector relates to size of the moving acceleration vector.

5. The control method of the naked eye stereoscopic display according to claim 1, wherein value of the correction vector relates to a weighted correction coefficient between 0.5 and 1.2.

6. The control method of the naked eye stereoscopic display according to claim 1, wherein the effective image width relates to a distance between the eye and the naked eye stereoscopic display.

7. The control method of the naked eye stereoscopic display according to claim 1, wherein a range of a bionic crosstalk percentage below a predetermined percentage is the effective image width.

8. The control method of the naked eye stereoscopic display according to claim 1, wherein each of the eye movement vector, the movement speed vector and the moving acceleration vector is a three-dimensional vector.

9. The control method of the naked eye stereoscopic display according to claim 1, wherein in the step of correcting the eye movement vector, the eye movement vector and the correction vector are added together.

10. The control method of the naked eye stereoscopic display according to claim 1, wherein the image position is obtained according to Snell's Law through reverse calculation of a lens geometric relationship.

11. A naked eye stereoscopic display, comprising:
an eye tracking unit, configured to track an eye to obtain an eye movement vector, a movement speed vector and a moving acceleration vector of the eye;
a vector calculation unit, configured to obtain a correction vector according to an effective image width, the movement speed vector and the moving acceleration vector;
a space correction unit, configured to correct the eye movement vector according to the correction vector; and
an image processing unit, configured to correct an image position of a monocular image at a plurality of pixels according to the eye movement vector, which is corrected.

12. The naked eye stereoscopic display according to claim 11, wherein a direction of the correction vector relates to a direction of the movement speed vector.

13. The naked eye stereoscopic display according to claim 11, wherein value of the correction vector relates to directional consistency between the movement speed vector and the moving acceleration vector.

14. The naked eye stereoscopic display according to claim 11, wherein value of the correction vector relates to size of the moving acceleration vector.

15. The naked eye stereoscopic display according to claim 11, wherein value of the correction vector relates to a weighted correction coefficient between 0.5 and 1.2.

16. The naked eye stereoscopic display according to claim 11, wherein the effective image width relates to a distance between the eye and the naked eye stereoscopic display.

17. The naked eye stereoscopic display according to claim 11, wherein a range of a bionic crosstalk percentage below a predetermined percentage is the effective image width.

18. The naked eye stereoscopic display according to claim 11, wherein each of the eye movement vector, the movement speed vector and the moving acceleration vector is a three-dimensional vector.

19. The naked eye stereoscopic display according to claim 11, wherein space correction unit adds the eye movement vector and the correction vector for correcting the eye movement vector.

20. The naked eye stereoscopic display according to claim 11, wherein the image position is obtained according to Snell's Law through reverse calculation of a lens geometric relationship.
